(19) United States
(12) Patent Application Publication
(10) Pub. No.: US 2018/0192821 A1
(43) Pub. Date: Jul. 12, 2018

(54) GRIDDLE PLATE WITH IMPROVED HEAT TRANSFER

(71) Applicant: Jade Range LLC, Brea, CA (US)

(72) Inventors: Peng Wang, Brea, CA (US); Jiri Rabas, Lynnwood, WA (US); Jian Lai, Placentia, CA (US); Danny Huynh, El Monte, CA (US); Ernesto Del Rio, Corona, CA (US)

(73) Assignee: Jade Range LLC, Brea, CA (US)

(21) Appl. No.: 15/863,344

(22) Filed: Jan. 5, 2018

Related U.S. Application Data
(60) Provisional application No. 62/445,494, filed on Jan. 12, 2017.
(60) Provisional application No. 62/485,621, filed on Apr. 14, 2017.

(51) Int. Cl. A47J 37/06

(52) U.S. Cl. CPC A47J 37/0676

(57) ABSTRACT

A Mongolian griddle assembly includes a housing including an annular wall and a cylindrical griddle plate disposed horizontally on the annular wall. The cylindrical griddle plate includes a first surface configured to support one or more food items and a second surface opposing the first surface. Projections are disposed on the second surface and extend from the second surface. A heat source is disposed within the housing and below the second surface such that heat generated by the heat source is transferred to the cylindrical griddle plate through the second surface.

### CROSS REFERENCE TO RELATED APPLICATIONS

This application claims priority from U.S. Provisional Application No. 62/445,494 filed Jan.12, 2017, and from U.S. Provisional Application No. 62/485,621 filed Apr. 14, 2017, the entirety of which are each fully incorporated by reference herein.

### BACKGROUND

Conventional griddle assemblies typically include a griddle plate configured to support food items during a cooking process. A heat source, such as one or more gas burners, is positioned under the griddle plate to heat the griddle plate to a temperature required to cook the food items placed on a top surface of the griddle plate. However, conventional griddle assemblies may perform poorly at least partially because the heat source does not adequately and/or consistently heat the entire top surface of the griddle plate due to poor combustion gas flow across a bottom surface of the griddle plate facing the heat source. Accordingly, a griddle assembly and an associated griddle plate that provide adequate and consistent heating performance are desired.

### SUMMARY

In one aspect, a griddle assembly includes a housing and a griddle plate disposed horizontally on the housing. The griddle plate includes a first surface configured to support one or more food items and a second surface opposing the first surface. A plurality of projections are disposed on the second surface and extend from the second surface towards a heat source disposed within the housing and below the second surface such that heat generated by the heat source is transferred to the griddle plate through the second surface.

In another aspect, a griddle plate for a griddle assembly includes a substantially planar first surface configured to support one or more food items. The first surface has a front edge, a first lateral side edge, a second lateral side edge opposite the first lateral side edge, and a rear edge opposite the front edge. The rear edge forms an opening along at least a portion of a width of the griddle plate between the first lateral side edge and the second lateral side edge. A second surface opposing the first surface includes a substantially planar base and a plurality of projections extending from the base.

In yet another aspect, a griddle plate for a griddle assembly includes a substantially planar first surface configured to support one or more food items. A second surface opposing the first surface includes a substantially planar base and a plurality of projections extending from the base. Each projection is spaced from adjacent projections to disrupt a flow of combustion gas across the second surface.

In yet another aspect, a Mongolian griddle assembly includes a housing having an annular wall. A cylindrical griddle plate is disposed horizontally on the annular wall. The cylindrical griddle plate includes a first surface configured to support one or more food items and a second surface opposing the first surface. A plurality of projections is disposed on the second surface with each projection extending from the second surface. A heat source is disposed within the housing and below the second surface such that heat generated by the heat source is transferred to the cylindrical griddle plate through the second surface.

### BRIEF DESCRIPTION OF THE DRAWINGS

FIG. 1 is a sectional front view of an example griddle assembly for cooking food items, according to various embodiments;

FIG. 2 is a perspective top view of an example griddle plate for the griddle assembly of FIG. 1, according to various embodiments;

FIG. 3 is a perspective bottom view of the example griddle plate shown in FIG. 2, according to various embodiments;

FIG. 4 is a plan view of a bottom surface of an example griddle plate, according to various embodiments;

FIG. 5 is a front plan view of the example griddle plate shown in FIG. 4, according to various embodiments;

FIG. 6 is a rear plan view of the example griddle plate shown in FIG. 4, according to various embodiments;

FIG. 7 is a sectional view of the example griddle plate shown in FIG. 4 along section line A-A, according to various embodiments;

FIG. 8 is a detailed view of a portion B of the example griddle plate shown in FIG. 7, according to various embodiments;

FIG. 9 is a detailed view of a portion C of the example griddle plate shown in FIG. 7, according to various embodiments;

FIG. 10 is a detailed view of a portion D of the example griddle plate shown in FIG. 6, according to various embodiments;

FIGS. 11A-11F show several example projections, according to various embodiments;

FIG. 12 is a perspective view of an example Mongolian griddle assembly including a griddle plate, according to various embodiments;

FIG. 13 is a perspective top view of an example griddle plate for the Mongolian griddle assembly of FIG. 12, according to various embodiments;

FIG. 14 is a perspective bottom view of the example griddle plate shown in FIG. 12, according to various embodiments;

FIG. 15 is a plan view of a bottom surface of an example griddle plate for the Mongolian griddle assembly of FIG. 12, according to various embodiments;

FIG. 16 is a sectional view of the example griddle plate shown in FIG. 15 along sectional line A-A, according to various embodiments;

FIG. 17 is an expanded view of a portion of the example griddle plate shown in FIG. 16, according to various embodiments; and

FIG. 18 is an expanded view of a portion of the example griddle plate shown in FIG. 16, according to various embodiments.

### DETAILED DESCRIPTION

In example embodiments, a griddle assembly for cooking food items includes a griddle plate supported by a housing of the griddle assembly in a substantially horizontal plane. The griddle plate has a planar top surface for supporting the food items and an opposing bottom surface including a plurality of spaced projections, such as a plurality of spaced hemispherical projections, extending downwardly from a base of the bottom surface toward one or more corresponding heat sources. In example embodiments, the griddle plate is heated using the one or more heat sources, e.g., gas burners, positioned below the griddle plate at a distance from the bottom surface. The combustion gas flow generated by the heat sources across the bottom surface becomes turbulent due to the presence of the hemispherical projections, which causes the combustion gas to reside below the griddle plate for a longer period of time to increase heat transfer from the heat sources to the griddle plate. Moreover, as compared to conventional griddle plates having a generally planar bottom surface, the spaced hemispherical projections of the example griddle plate provide an increased surface area across the bottom surface to facilitate consistent, enhanced heat transfer to the griddle plate.

Referring to the figures, in example embodiments, a griddle assembly for cooking food items is disclosed. The griddle assembly includes a griddle plate configured to support one or more food items during the cooking processes. The example griddle plate is formed of a cast iron material; however, in alternative embodiments, the griddle plate may be formed of any suitable material, such as steel, aluminum, cast iron, or a combination of materials such as aluminum and steel composite, capable of withstanding high temperatures and harsh environments over relatively long time periods to which griddle plates are exposed. In example embodiments, the griddle plate is formed as a continuous monolithic component.

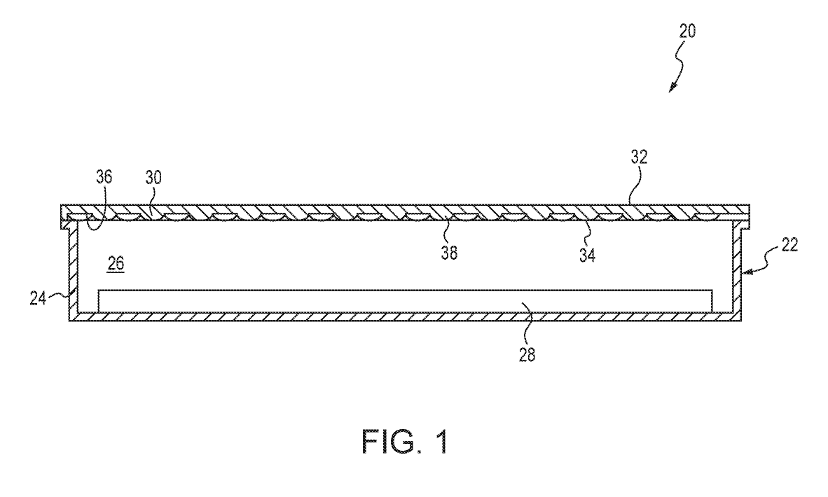

Referring first to FIG. 1, a griddle assembly 20 includes a housing 22 made of a suitable conventional material, such as stainless steel. Housing 22 includes a plurality of walls 24 forming a cavity 26. One or more heat sources 28, e.g., one or more gas burners (shown schematically), are disposed within cavity 26. A griddle plate 30 is disposed on housing 22 and supported by walls 24 to extend over cavity 26 in a substantially horizontal plane. Griddle plate 30 includes a substantially planar first or top surface 32 configured to support one or more food items and a second or bottom surface 34 opposing top surface 32. In example embodiments, bottom surface 34 includes a substantially planar base 36 and a plurality of projections 38, such as a plurality of hemispherical projections, disposed on base 36 and extending downwardly from base 36. As shown in FIG. 1, one or more heat sources 28 are disposed within cavity 26 and below bottom surface 34 at a suitable distance from bottom surface 34 such that heat generated by the one or more heat sources 28 is transferred to griddle plate 30 through bottom surface 34. Heat generated by heat sources 28 is transferred through griddle plate 30 to cook the food items supported on top surface 32.

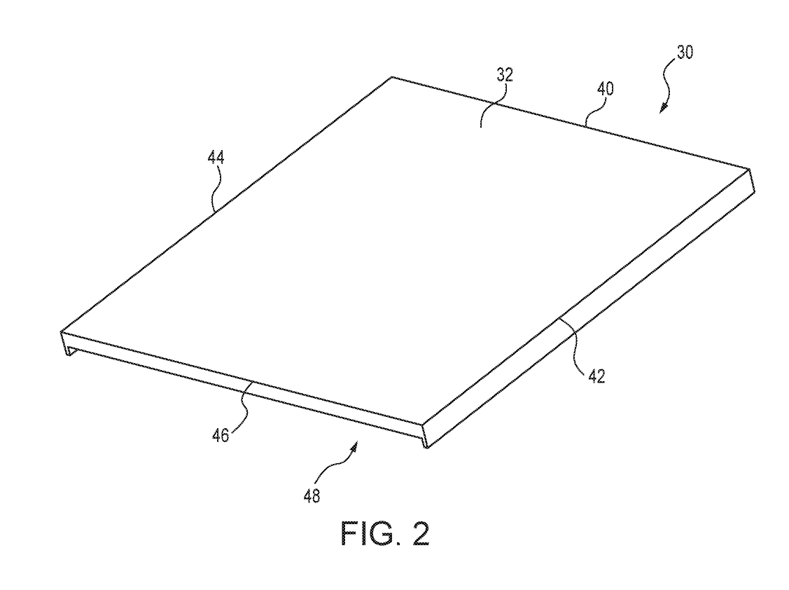

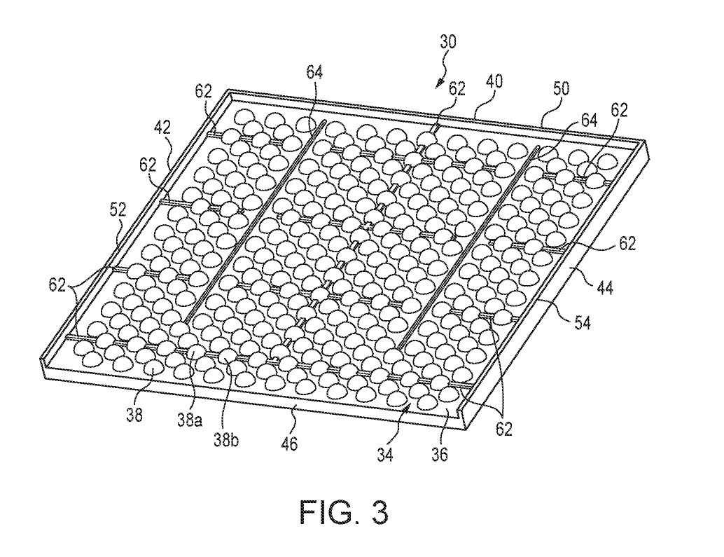

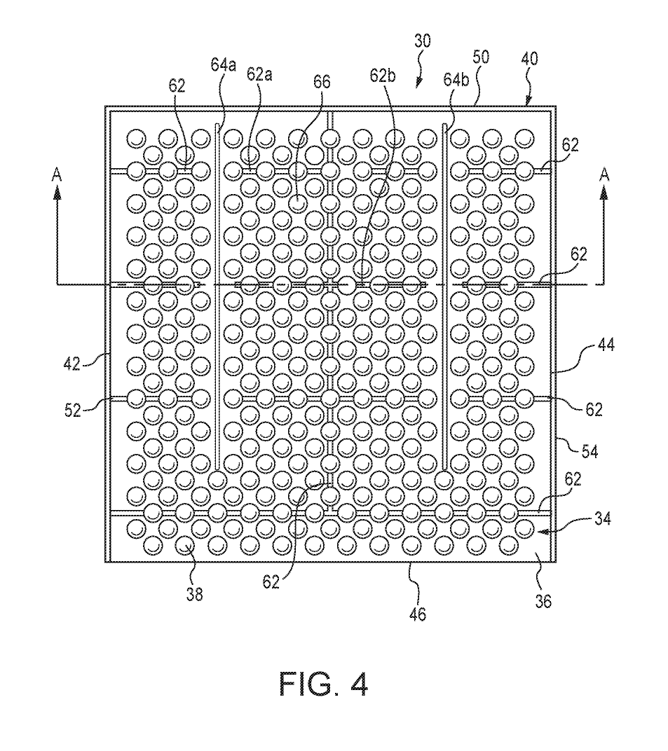

FIGS. 2-11 show various views of example griddle plate 30. As shown in FIG. 2, top surface 32 of griddle plate 30 is substantially planar and configured to support one or more food items during a cooking process. Referring further to FIGS. 3 and 4, griddle plate 30 includes respective side walls along a front edge and along the lateral side edges of the griddle plate. More specifically, as shown in FIG. 2, top surface 32 has a front edge 40, a first lateral side edge 42, a second lateral side edge 44 opposite first lateral side edge 42, and a rear edge 46 opposite front edge 40. As shown in FIGS. 2-4, rear edge 46 forms an opening 48 along at least a portion of a width of griddle plate 30 between first lateral side edge 42 and second lateral side edge 44. In example embodiments, rear edge 46 is open to facilitate combustion gas flow across bottom surface 34 from front edge 40 towards rear edge 46. As shown in FIGS. 3 and 4, for example, griddle plate 30 includes a front wall 50 along at least a portion of front edge 40, a first side wall 52 along at least a portion of first lateral side edge 42, and a second side wall 54 along at least a portion of second lateral side edge 44. Referring further to FIG. 9, in example embodiments, first side wall 52 has a height, Hw, from base 36 to an end surface of first side wall 52 of 0.25 inch to 0.75 inch and, more particularly, 0.50 inch. Further, first side wall 52 has a width, Ww, defined between an outer surface of first side wall 52 and an opposing inner surface of first side wall 52 of 0.125 inch to 0.75 inch and, more particularly, 0.25 inch to 0.50 inch and, even more particularly, 0.25 inch. In example embodiments, front wall 50 and second side wall 54 have a height and a width equal to the height, Hw, and the width, Ww, respectively, of first side wall 52. In alternative embodiments, front wall 50, first side wall 52, and/or second side wall 54 may have any suitable thickness less than 0.25 inch or greater than 0.75 inch. In alternative embodiments, griddle plate 30 does not include front wall 50, first side wall 52, and/or second side wall 54. In further alternative embodiments, each of front wall 50, first side wall 52, and/or second side wall 54 may have a suitable height less than 0.25 inch or greater than 0.75 inch and/or a width less than 0.125 inch or greater than 0.75 inch.

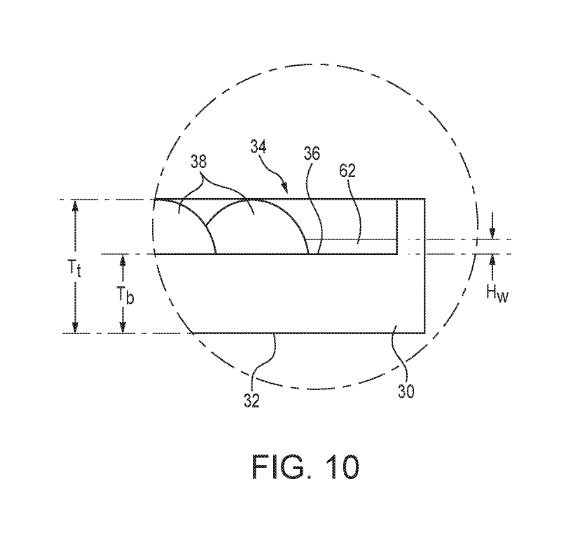

As shown in FIGS. 3 and 4, in example embodiments, bottom surface 34 includes a substantially planar base 36 substantially parallel to top surface 32. Referring further to FIG. 10, in example embodiments, griddle plate 30 has a total thickness, Tt, defined between top surface 32 and an end surface of front wall 50, first side wall 52, and/or second side wall 54 of 1.0 inch to 2.0 inches and, more particularly, 1.125 inches to 1.50 inches and, even more particularly, 1.250 inches to 1.50 inches. Further, griddle plate 30 has a base thickness, Tb, defined between top surface 32 and a surface of base 36 of 0.50 inch to 1.0 inch and, more particularly, 0.50 inch to 0.75 inch and, even more particularly, 0.75 inch.

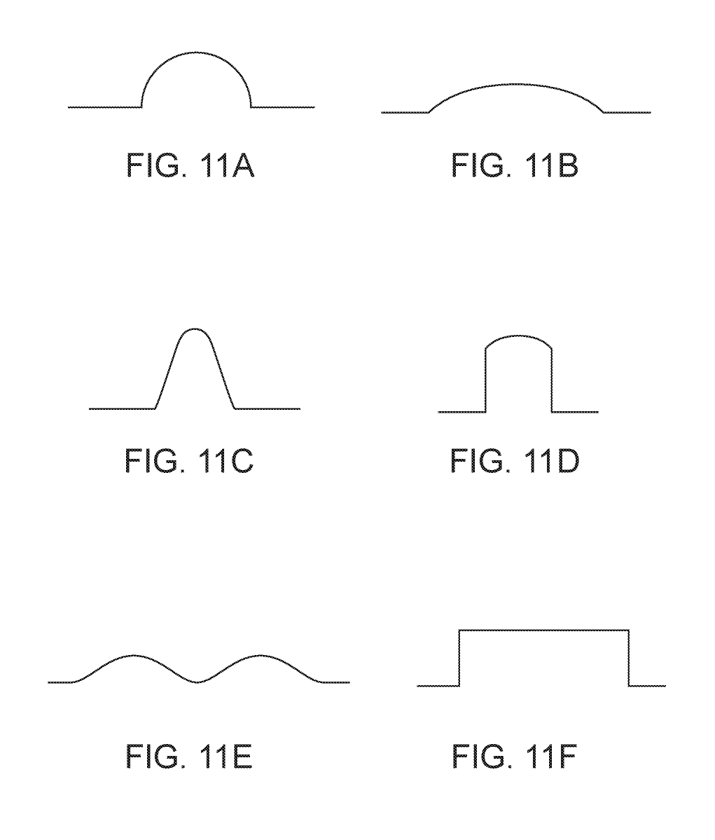

Projections 38, such as a plurality of spaced hemispherical projections or other projections having suitable dimensions and configurations, extend from base 36, as shown in FIGS. 3 and 4. Referring further to FIGS. 11A-11F, in example embodiments, the plurality of projections 38 may include one or more of the following: a hemispherical projection (FIG. 11A), a dimple (FIG. 11B), a ridge (FIG. 11C), a lip (FIG. 11D), an undulation (FIG. 11E), and/or a wall (FIG. 11F), for example. Other suitably sized and configured projections may also be disposed on base 36. In example embodiments, each projection 38 has a width, e.g., a diameter, of 0.25 inch to 1.75 inches and, more particularly, a width of 0.75 inch to 1.25 inches, and a height, e.g., a radius, from base 36 of 0.25 inch to 0.75 inch and, more particularly, 0.50 inch to 0.60 inch. In example embodiments in which projections 38 are hemispherical projections, each projection 38 has a radius, such as radius Rp shown in FIG. 9, of 0.25 inch to 0.75 inch and, more particularly, 0.50 inch. As a result, in these embodiments, hemispherical projections 38 have a width, i.e., a diameter, of 0.50 inch to 1.50 inch and a height of 0.25 inch to 0.75 inch and, more particularly, a diameter of 1.0 inch and a height of 0.5 inch.

Further, in example embodiments, each projection 38 is spaced from adjacent projections 38 by a suitable distance to facilitate disruption of combustion gas flow across bottom surface 34, as described herein. For example, in certain embodiments, a first projection of the plurality of projections is spaced from adjacent projections of the plurality of projections, for example, in a lateral direction between first lateral side edge 42 and second lateral side edge 44, at a distance of less than 1.0 inch. Moreover, in example embodiments in which projections 38 are hemispherical projections, a center point of each projection 38 is spaced from a center point of adjacent projections 38 in a lateral direction at a distance of 3.0 inches to 1.0 inch and, more particularly, a distance of 2.0 inches to 1.5 inches. Further, in certain example embodiments, projections 38 are disposed on bottom surface 34 in a plurality of rows of projections that extend from front edge 40 to rear edge 46. Each projection 38 within each respective row of the plurality of rows of projections is aligned at an equal distance from adjacent projections 38 within the respective row. Depending on the dimensions and configuration of projections 38, this distance may be greater than 1.0 inch. While in example embodiments, as shown in FIGS. 3 and 4, each projection 38 is equally spaced from adjacent projections 38, in alternative embodiments, projections 38 may be unequally spaced from one or more adjacent projections 38. In alternative embodiments, projections 38 have a straight pattern rather than a staggered pattern. Further, projections 38 may be formed on base 36 such that each projection 38 interferes with one or more adjacent projections having a minimum distance between center points of adjacent projections 38 less than 1.0 inch but greater than 0.5 inch.

With griddle plate 30 properly positioned within housing 22 of griddle assembly 20, top surface 32 forms a suitable planar surface for supporting one or more food items during a cooking process and opposing bottom surface 34 faces one or more heat sources 28, such as one or more gas burners, as described above. In example embodiments, each projection 38 extends from base 36 towards an associated heat source 28, e.g., an associated gas burner. In this configuration, heat sources 28 generate a combustion gas flow that flows towards and across bottom surface 34 of griddle plate 30. In example embodiments, each projection 38 is spaced from adjacent projections 38 to disrupt a flow of combustion gas across bottom surface 34. For example, projections 38 are spaced on base 36 such that the combustion gas cannot flow across bottom surface 34 without one or more projections 38 disrupting the flow and altering a direction of the flow across bottom surface 34. As the combustion gas flows across bottom surface 34, the combustion gas flow becomes turbulent. As a result, the combustion gas resides below griddle plate 30 for a longer period of time as it flows between and/or over projections 38, which increases heat transfer from heat sources 28 to griddle plate 30. Additionally, projections 38 provide additional surface area for the combustion gas to contact as it flows across bottom surface 34 of griddle plate 30, thereby facilitating consistent heat transfer to griddle plate 30.

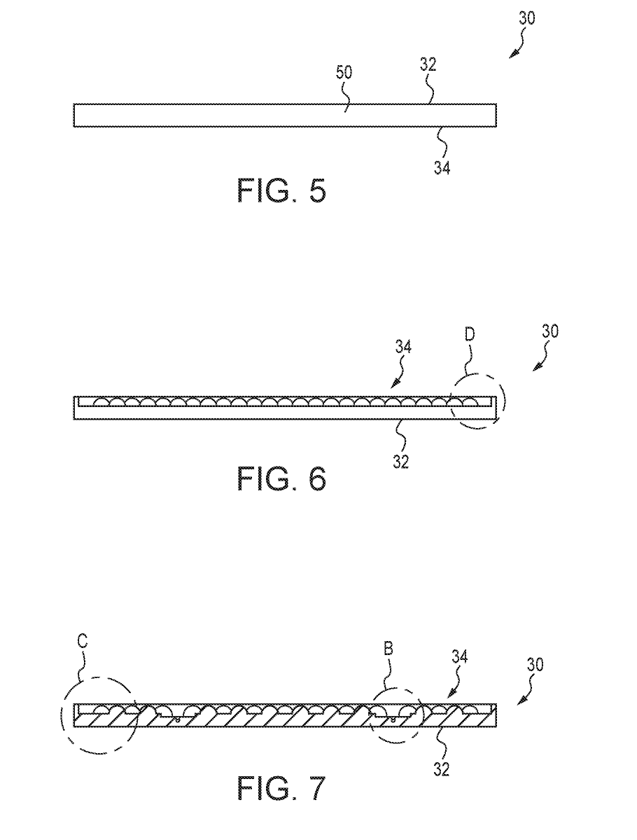

FIGS. 5-7 show various side views of example griddle plate 30. More specifically, FIG. 5 is a front plan view of griddle plate 30 illustrating front wall 50; FIG. 6 is a rear plan view of griddle plate 30 illustrating rear edge 46 and opening 48 and including detail portion D; and FIG. 7 is a sectional view of griddle plate 30 along section line A-A shown in FIG. 4 and including detail portions B and C.

Referring again to FIGS. 3 and 4, as well as to FIGS. 6 and 10, in certain example embodiments, one or more walls 62 are disposed on base 36 to further disrupt the combustion gas flow and/or alter a direction of the combustion gas flow across bottom surface 34. For example, referring to FIGS. 3 and 5, a plurality of parallel walls 62 are disposed on base 36 with each wall 62 extending from base 36 across at least a portion of the width of griddle plate 30 between first lateral side edge 42 and second lateral side edge 44. In certain embodiments, one or more walls 62 extend between a first projection 38a of the plurality of projections 38 and a second projection 38b of the plurality of projections 38 adjacent first projection 38a, as shown in FIG. 3. In example embodiments, as shown in FIG. 10, each wall 62 has a height, Hw, from base 36 to an end surface of wall 62 of 0.083 inch to 0.250 inch and, more particularly, 0.125 inch to 0.167 inch, and a width, perpendicular to the height, of 0.125 inch to 0.50 inch and, more particularly, 0.167 inch to 0.25 inch.

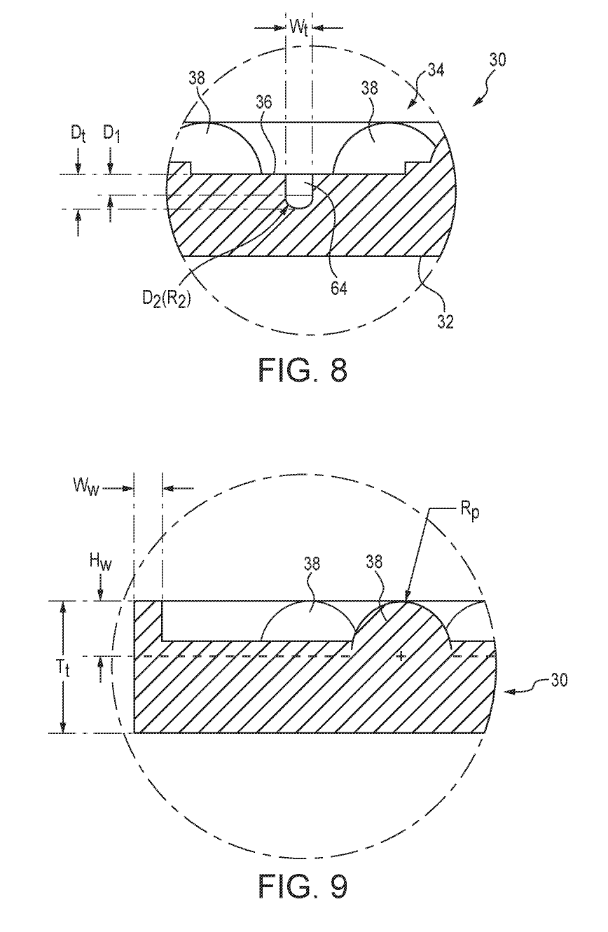

Referring now to FIGS. 3 and 4, as well as to FIGS. 7 and 8, in certain example embodiments, one or more channels 64 are formed in base 36. For example, a plurality of parallel channels 64 are formed in base 36 with each channel 64 extending along at least a portion of a depth of griddle plate 30, perpendicular to the width of griddle plate 30, between front edge 40 and rear edge 46 of griddle plate 30. In example embodiments, channels 64 are configured to promote the combustion gas flow across bottom surface 34 in a direction from front edge 40 towards rear edge 46. In certain embodiments, a first channel 64a extends between a first row of projections and a second row of projections adjacent the first row of projections, as shown in FIG. 4. Referring to FIG. 8, in example embodiments, each channel 64 has a total depth, Dt, from a surface of base 36 of 0.125 inch to 0.50 inch and, more particularly, a depth from base 36 of at least 0.188 inch, and a width, Wt, perpendicular to the depth, of 0.125 inch to 0.50 inch and, more particularly, 0.167 inch to 0.25 inch. In a particular embodiment, channel 64 has a first depth, D₁, of 0.188 inch and a second depth, D₂, i.e., R₂, of 0.125 inch such that the total depth, Dt, is 0.313 inch.

In example embodiments, as described above, a plurality of parallel walls 62 are disposed on base 36 with each wall 62 extending from base 36 across at least a portion of the width of griddle plate 30 between first lateral edge 42 and second lateral side edge 44. A plurality of parallel channels 64 are formed in base 36 with each channel 64 extending along at least a portion of a depth of griddle plate 30, perpendicular to the width, between front edge 40 and rear edge 46. In these embodiments, one or more walls 62, such as a first wall 62a, of the plurality of parallel walls 62 and a second wall 62b of the plurality of walls 62 extend between a first parallel channel 64a of the plurality of parallel channels 64 and a second parallel channel 64b of the plurality of parallel channels 64 to define a respective heating area 66 of griddle plate 30. In these embodiments, channels 64 promote flow of combustion gas across bottom surface 34 into heating area 66 and first wall 62a and second wall 62b disrupt the flow of combustion gas such that the combustion gas is maintained within heating area 66, at least temporarily, to adequately heat griddle plate 30 within heating area 66.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

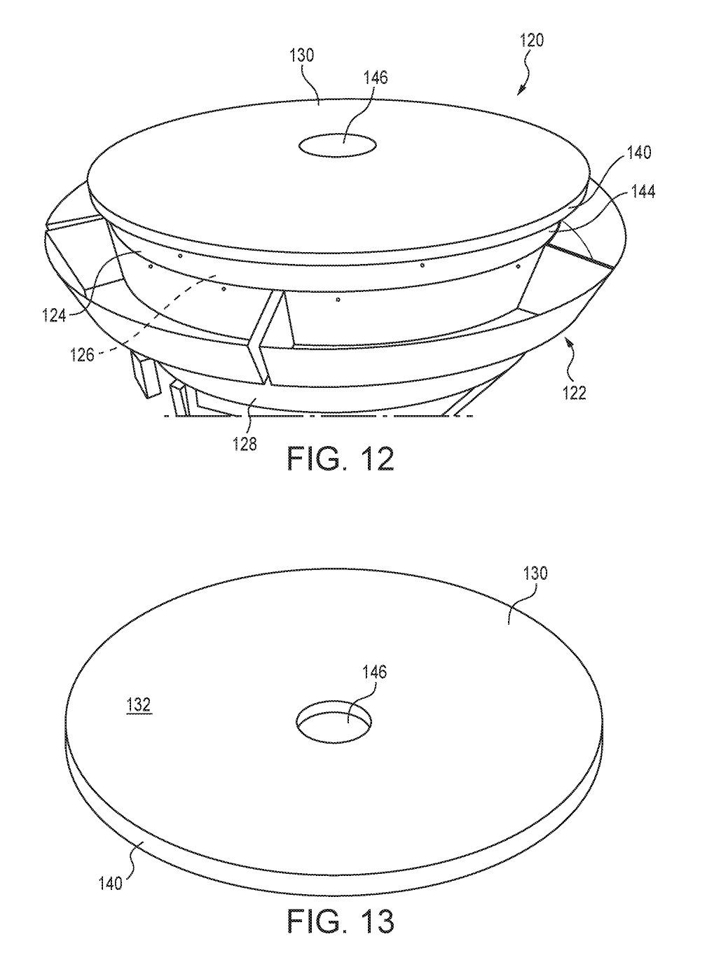

Referring to FIGS. 12-17, a Mongolian griddle assembly 120 includes a housing 122 made of a suitable conventional material, such as stainless steel. Housing 122 includes an annular wall 124 forming a cavity 126. One or more heat sources 128, e.g., one or more gas burners (shown schematically), are disposed under or within cavity 126. A cylindrical griddle plate 130 is disposed on housing 122 and supported by annular wall 124 to extend over cavity 126 in a substantially horizontal plane. In certain example embodiments, griddle plate 130 is made of a suitable material, such as cast iron, as a continuous monolithic component. Griddle plate 130 includes a substantially planar first or top surface 132 configured to support one or more food items and a second or bottom surface 134 opposing top surface 132. In example embodiments, bottom surface 134 includes a substantially planar base 136 and a plurality of projections 138, such as a plurality of hemispherical projections, disposed on base 136 and extending downwardly from base 136. As shown in FIG. 12, one or more heat sources 128 are disposed with respect to, e.g., under or within, cavity 126 and below bottom surface 134 at a suitable distance from bottom surface 134 such that heat generated by the one or more heat sources 128 is transferred to griddle plate 130 through bottom surface 134. Heat generated by heat sources 128 is transferred through griddle plate 130 to cook the food items supported on top surface 132.

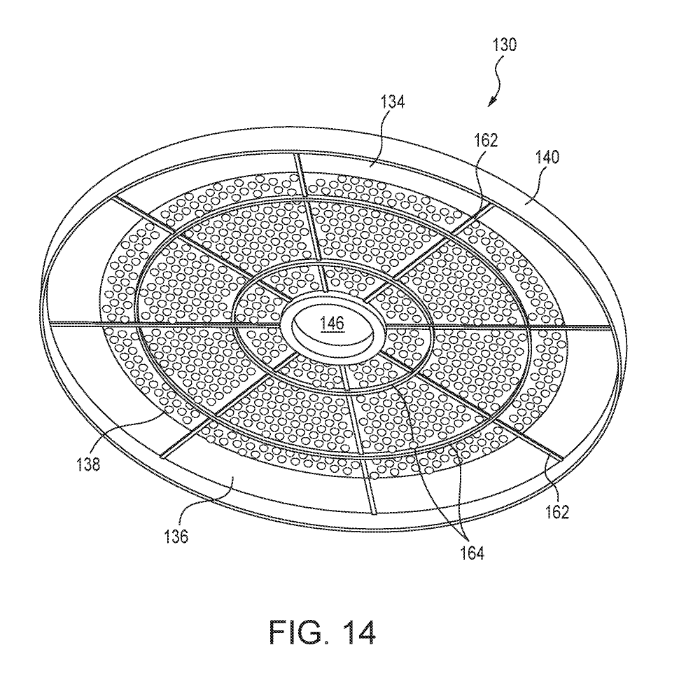

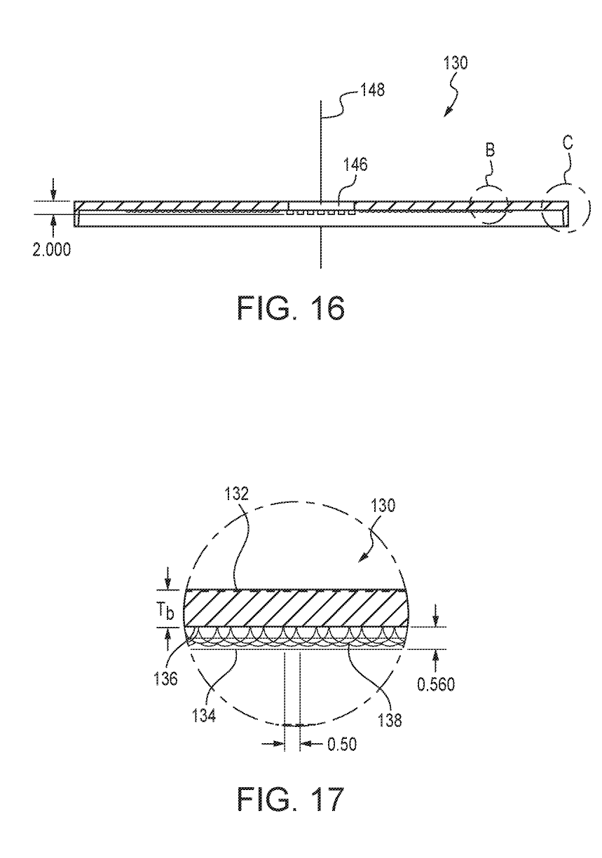

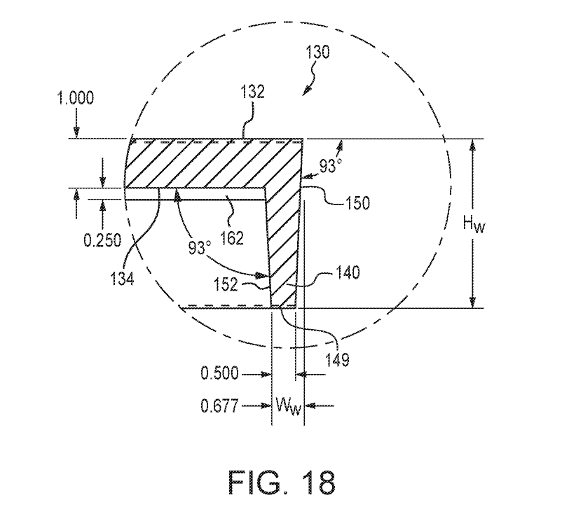

FIGS. 13-18 show various views of example griddle plate 130. As shown in FIG. 13, top surface 132 of griddle plate 130 is substantially circular and planar to support one or more food items during a cooking process. Referring further to FIGS. 14, 15, 16 and 18, griddle plate 130 includes an annular side wall 140 extending about a periphery of top surface 132 of griddle plate 130. As shown in FIG. 12, griddle plate 130 is disposed on annular wall 124 such that annular side wall 140 extends over a portion of an outer surface 144 of annular wall 124. Further, griddle plate 130 may include a centrally-located opening 146, e.g., an opening 146 having a circular cross-sectional shape coaxially positioned with respect to a central axis 148 (shown in FIG. 16) of griddle plate 130. In certain example embodiments, opening 146 facilitates combustion gas flow across bottom surface 134 towards opening 146. Referring further to FIG. 18, in example embodiments, annular side wall 140 has a height, Hw, from top surface 132 base to an end surface 149 of annular side wall 140 of 3.00 inches to 5.00 inches and, more particularly, 3.50 inches to 4.50 inches. Further, annular side wall 140 has a width, Ww, defined between an outer surface 150 of annular side wall 140 and an opposing inner surface 152 of annular side wall 140 that tapers from top surface 132 to end surface 149. In example embodiments, width, Ww, at bottom surface 134 is 0.25 inch to 1.00 inch and, more particularly, 0.50 inch to 0.75 inch and, even more particularly, 0.67 inch and width, Ww, at end surface 149 is 0.125 inch to 0.75 inch and, more particularly, 0.25 inch to 0.75 inch and, even more particularly, 0.50 inch. In alternative embodiments, annular side wall 140 may have any suitable height and width.

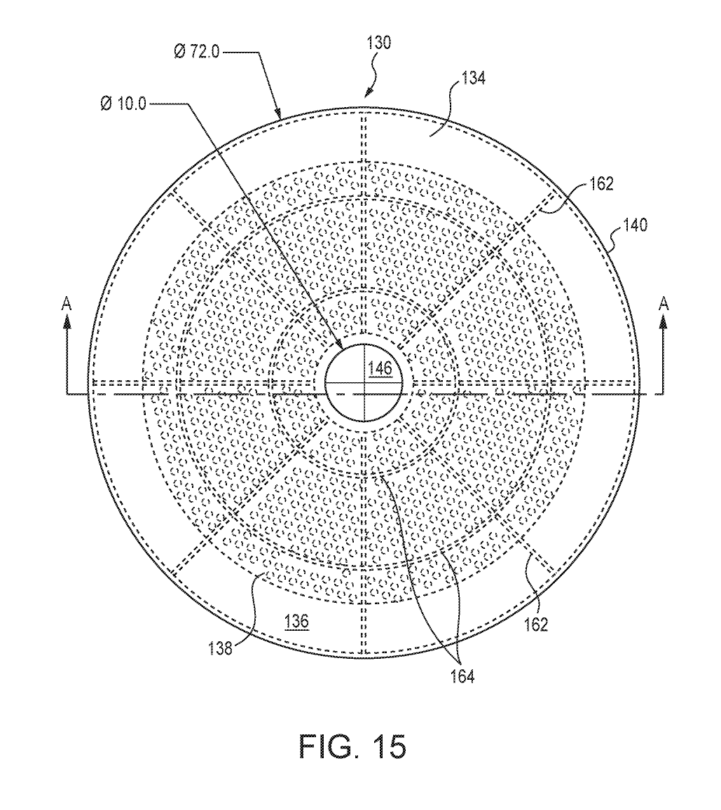

As shown in FIGS. 14-17, in example embodiments, bottom surface 134 includes a substantially planar base 136 substantially parallel to top surface 132. Referring further to FIG. 17, in example embodiments, griddle plate 130 has a base thickness, Tb, defined between top surface 132 and a surface of base 136 of 0.50 inch to 1.50 inches and, more particularly, 0.75 inch to 1.25 inches and, even more particularly, 1.00 inch. Projections 138, such as a plurality of spaced hemispherical projections or other projections having suitable dimensions and configurations, extend from base 136, as shown in FIGS. 15 and 17, for example. As described above with reference to FIGS. 11A-11F, in example embodiments, each projection 138 may having similar dimensions and configurations as described above in reference to projections 38. For example, projections 138 may include one or more of the following: a hemispherical projection (FIG. 11A), a dimple (FIG. 11B), a ridge (FIG. 11C), a lip (FIG. 11D), an undulation (FIG. 11E), and/or a wall (FIG. 11F), for example. Other suitably sized and configured projections may also be disposed on base 136. In example embodiments, each projection 138 has a width, e.g., a diameter, of 0.25 inch to 1.75 inches and, more particularly, a width of 0.75 inch to 1.25 inches, and a height, e.g., a radius, from base 136 of 0.25 inch to 0.75 inch and, more particularly, 0.50 inch to 0.60 inch. In example embodiments in which projections 138 are hemispherical projections, each projection 138 has a radius of 0.25 inch to 0.75 inch and, more particularly, 0.50 inch. As a result, in these embodiments, hemispherical projections 138 have a width, i.e., a diameter, of 0.50 inch to 1.50 inch and a height of 0.25 inch to 0.75 inch and, more particularly, a diameter of 1.0 inch and a height of 0.5 inch.

Further, in example embodiments, each projection 138 is spaced from adjacent projections 138 by a suitable distance to facilitate disruption of combustion gas flow across bottom surface 134, as described herein. For example, in certain embodiments, a first projection of the plurality of projections is spaced from adjacent projections of the plurality of projections, for example, in a lateral direction between a first lateral side edge and a second lateral side edge, at a distance of less than 1.0 inch. Moreover, in example embodiments in which projections 138 are hemispherical projections, a center point of each projection 138 is spaced from a center point of adjacent projections 138 in a lateral direction at a distance of 3.0 inches to 1.0 inch and, more particularly, a distance of 2.0 inches to 1.5 inches. Further, projections 138 may be formed on base 136 such that each projection 138 interferes with one or more adjacent projections having a minimum distance between center points of adjacent projections 138 less than 1.0 inch but greater than 0.5 inch.

With griddle plate 130 properly positioned on annular wall 124 of griddle assembly 120, top surface 132 forms a suitable planar surface for supporting one or more food items during a cooking process and opposing bottom surface 134 faces one or more heat sources 128, such as one or more gas burners, as described above. In example embodiments, each projection 138 extends from base 136 towards an associated heat source 128, e.g., an associated gas burner. In this configuration, heat sources 128 generate a combustion gas flow that flows towards and across bottom surface 134 of griddle plate 130. In example embodiments, each projection 138 is spaced from adjacent projections 138 to disrupt a flow of combustion gas across bottom surface 134. For example, projections 138 are spaced on base 136 such that the combustion gas cannot flow across bottom surface 134 without one or more projections 138 disrupting the flow and altering a direction of the flow across bottom surface 134. As the combustion gas flows across bottom surface 134, the combustion gas flow becomes turbulent. As a result, the combustion gas resides below griddle plate 130 for a longer period of time as it flows between and/or over projections 138, which increases heat transfer from heat sources 128 to griddle plate 130. Additionally, projections 138 provide additional surface area for the combustion gas to contact as it flows across bottom surface 134 of griddle plate 130, thereby facilitating consistent heat transfer to griddle plate 130.

Referring again to FIGS. 14 and 15, in certain example embodiments, one or more radial walls 162 are disposed on base 136 to further disrupt the combustion gas flow and/or alter a direction of the combustion gas flow across bottom surface 134. For example, a plurality of radial walls 162 are disposed on base 136 with each radial wall 162 extending radially outward from opening 146 towards annular side wall 140. In example embodiments, as shown in FIGS. 14 and 15, each radial wall 162 has a height, Hw, from base 136 to an end surface of radial wall 162 of 0.083 inch to 0.250 inch and, more particularly, 0.125 inch to 0.167 inch, and a width, perpendicular to the height, of 0.125 inch to 0.50 inch and, more particularly, 0.167 inch to 0.25 inch. Also as shown in FIGS. 14 and 15, in certain example embodiments, one or more annular walls 164 are formed concentrically in base 136 with respect to central axis 148. In example embodiments, annual walls 164 are configured to promote the combustion gas flow across bottom surface 134. In certain embodiments, each annular wall 164 has a height, Hw, from base 136 to an end surface of annular wall 164 of 0.083 inch to 0.250 inch and, more particularly, 0.125 inch to 0.167 inch, and a width, perpendicular to the height, of 0.125 inch to 0.50 inch and, more particularly, 0.167 inch to 0.25 inch. Annular walls 164 may have the same or a different height as radial walls 162. In alternative embodiments, one or more radial walls 162 and/or one or more annular walls 164 may be replaced with a respective channel formed in base 136 having a total depth, Dt, from a surface of base 136 of 0.125 inch to 0.50 inch and, more particularly, a depth from base 136 of at least 0.188 inch, and a width, Wt, perpendicular to the depth, of 0.125 inch to 0.50 inch and, more particularly, 0.167 inch to 0.25 inch. In these embodiments, the channels promote flow of combustion gas across bottom surface 134 and radial walls 162 and/or annular walls 164 disrupt the flow of combustion gas such that the combustion gas is maintained within heating areas, at least temporarily, to adequately heat griddle plate 130 within the heating areas.

One skilled in the art will realize that a virtually unlimited number of variations to the above descriptions are possible, and that the examples and the accompanying figures are merely to illustrate one or more examples of implementations.

It will be understood by those skilled in the art that various other modifications can be made, and equivalents can be substituted, without departing from claimed subject matter. Additionally, many modifications can be made to adapt a particular situation to the teachings of claimed subject matter without departing from the central concept described herein. Therefore, it is intended that claimed subject matter not be limited to the particular embodiments disclosed, but that such claimed subject matter can also include all embodiments falling within the scope of the appended claims, and equivalents thereof.

In the detailed description above, numerous specific details are set forth to provide a thorough understanding of claimed subject matter. However, it will be understood by those skilled in the art that claimed subject matter can be practiced without these specific details. In other instances, methods, devices, or systems that would be known by one of ordinary skill have not been described in detail so as not to obscure claimed subject matter.

Reference throughout this specification to “one embodiment” or “an embodiment” can mean that a particular feature, structure, or characteristic described in connection with a particular embodiment can be included in at least one embodiment of claimed subject matter. Thus, appearances of the phrase “in one embodiment” or “an embodiment” in various places throughout this specification are not necessarily intended to refer to the same embodiment or to any one particular embodiment described. Furthermore, it is to be understood that particular features, structures, or characteristics described can be combined in various ways in one or more embodiments. In general, of course, these and other issues can vary with the particular context of usage. Therefore, the particular context of the description or the usage of these terms can provide helpful guidance regarding inferences to be drawn for that context.

What is claimed is:

1. A griddle assembly, comprising:
a housing;
a griddle plate disposed horizontally on the housing, the griddle plate comprising:
a first surface configured to support one or more food items;
a second surface opposing the first surface; and
a plurality of projections disposed on the second surface and extending from the second surface; and
a heat source disposed within the housing and below the second surface such that heat generated by the heat source is transferred to the griddle plate through the second surface.

2. The griddle assembly of claim 1, wherein the griddle plate is a continuous monolithic component.

3. The griddle assembly of claim 1, wherein each projection of the plurality of projections comprises one of the following: a hemispherical projection, a dimple, a ridge, a lip, an undulation, and/or a wall.

4. The griddle assembly of claim 1, wherein the griddle plate includes a first lateral side edge and an opposing lateral side edge, and a first projection of the plurality of projections is spaced from an adjacent projection of the plurality of projections in a lateral direction between the first lateral side edge and the opposing lateral side edge at a distance of less than 1.0 inch.

5. The griddle assembly of claim 1, wherein the griddle plate includes a front edge and an opposing rear edge, and the plurality of projections are disposed on the second surface in a plurality of rows of projections that extend from the front edge to the rear edge, and each projection of the plurality of projections within each respective row of the plurality of rows of projections is aligned at an equal distance from adjacent projections within the respective row.

6. The griddle assembly of claim 1, wherein each projection of the plurality of projections is spaced from adjacent projections of the plurality of projections to disrupt a flow of combustion gas across the second surface.

7. The griddle assembly of claim 1, further comprising a wall disposed on and extending from the second surface to disrupt combustion gas flow across the second surface from a front edge of the griddle plate towards an opposing rear edge of the griddle plate.

8. The griddle assembly of claim 1, further comprising a channel formed in the second surface to promote combustion gas flow across the second surface from a front edge of the griddle plate towards an opposing rear edge of the griddle plate.

9. The griddle assembly of claim 1, wherein with the griddle plate positioned within a housing of the griddle assembly, the second surface faces the heat source such that each projection of the plurality of projections extends from the second surface towards the heat source.

10. A griddle plate for a griddle assembly, the griddle plate comprising:
a substantially planar first surface configured to support one or more food items, the first surface having a front edge, a first lateral side edge, a second lateral side edge opposite the first lateral side edge, and a rear edge opposite the front edge, the rear edge forming an opening along at least a portion of a width of the griddle plate between the first lateral side edge and the second lateral side edge; and
a second surface opposing the first surface, the second surface including a substantially planar base and a plurality of projections extending from the base.

11. The griddle plate of claim 10, wherein each projection of the plurality of projections comprises one of the following: a hemispherical projection, a dimple, a ridge, a lip, an undulation, or a wall.

12. The griddle plate of claim 10, wherein each projection of the plurality of projections is spaced from adjacent projections of the plurality of projections to disrupt a flow of combustion gas across the second surface.

13. The griddle plate of claim 10, further comprising one or more walls disposed on and extending from the base to disrupt the combustion gas flow across the second surface.

14. The griddle plate of claim 13, wherein the one or more walls comprises a plurality of parallel walls disposed on the base with each wall of the plurality of parallel walls extending from the base across at least a portion of a width of the griddle plate between the first lateral side edge and the second lateral side edge.

15. The griddle plate of claim 13, wherein the one or more walls comprises a first wall extending between a first projection of the plurality of projections and a second projection of the plurality of projections adjacent the first projection.

16. The griddle plate of claim 13, wherein the one or more walls comprises a first wall having a height from the base to an end surface of the wall of 0.083 inch to 0.250 inch and a width, perpendicular to the height, of 0.125 inch to 0.50 inch.

17. The griddle plate of claim 10, further comprising one or more channels in the base to promote the combustion gas flow across the second surface from the front edge towards the rear edge.

18. The griddle plate of claim 17, wherein the one or more channels comprises a plurality of parallel channels in the base with each channel of the plurality of parallel channels extending along at least a portion of a depth of the griddle plate between the front edge and the rear edge.

19. The griddle plate of claim 17, wherein the one or more channels comprises a first channel extending between a first projection of the plurality of projections and a second projection of the plurality of projections adjacent the first projection.

20. The griddle plate of claim 13, wherein the one or more channels comprises a first channel having a depth from the base of 0.125 inch to 0.50 inch and a width perpendicular to the height of 0.125 inch to 0.50 inch.

21. The griddle plate of claim 10, further comprising:
a plurality of parallel walls disposed on the base, each wall of the plurality of parallel walls extending from the base across at least a portion of a width of the griddle plate between the first lateral edge and the second lateral side edge; and
a plurality of parallel channels in the base, each channel of the plurality of parallel channels extending along at least a portion of a depth of the griddle plate, perpendicular to the width, between the front edge and the rear edge,
wherein a first wall of the plurality of parallel walls and a second wall of the plurality of walls each extends between a first parallel channel of the plurality of parallel channels and a second parallel channel of the plurality of parallel channels to define a heating area of the griddle plate.

22. The griddle plate of claim 10, further comprising:
a front wall along the front edge;
a first side wall along the first lateral side edge; and
a second side wall along the second lateral side edge.

23. The griddle plate of claim 22, wherein at least one of the front wall, the first side wall, or the second side wall has a height from the base to an end surface of 0.25 inch to 0.75 inch.

24. The griddle plate of claim 23, wherein the griddle plate has a total thickness between the first surface and an end surface of the front wall of 1.250 inch.

25. The griddle plate of claim 10, wherein a first projection of the plurality of projections has a width of 0.25 inch to 1.75 inches.

26. The griddle plate of claim 10, wherein a first projection of the plurality of projections has a height from the base of 0.25 inch to 0.75 inch.

27. The griddle plate of claim 26, wherein a first projection of the plurality of projections is spaced from an adjacent projection of the plurality of projections in a lateral direction at a distance of less than 1.0 inch.

28. The griddle plate of claim 26, wherein a center point of a first projection of the plurality of projections is spaced from a center point of an adjacent projection of the plurality of projections in a lateral direction at a distance less than 1.0 inch.

29. A griddle plate for a griddle assembly, the griddle plate comprising:
a substantially planar first surface configured to support one or more food items;
an opposing second surface including a substantially planar base and a plurality of projections extending from the base, wherein each projection of the plurality of projections is spaced from adjacent projections of the plurality of projections.

30. The griddle plate of claim 29, further comprising one or more walls disposed on and extending from the base.

31. The griddle plate of claim 29, further comprising one or more channels formed in the base substantially perpendicular to the one or more walls.

32. A Mongolian griddle assembly, comprising:
a housing including an annular wall;
a cylindrical griddle plate disposed horizontally on the annular wall, the cylindrical griddle plate comprising:
a first surface configured to support one or more food items;
a second surface opposing the first surface; and
a plurality of projections disposed on the second surface and extending from the second surface; and
a heat source disposed within the housing and below the second surface such that heat generated by the heat source is transferred to the cylindrical griddle plate through the second surface.

33. The Mongolian griddle assembly of claim 32, wherein the cylindrical griddle plate is a continuous monolithic component.

34. The Mongolian griddle assembly of claim 32, wherein each projection of the plurality of projections comprises one of the following: a hemispherical projection, a dimple, a ridge, a lip, an undulation, and/or a wall.

35. The Mongolian griddle assembly of claim 32, wherein the cylindrical griddle plate includes an annular side wall extending about a periphery of the first surface.

36. The Mongolian griddle assembly of claim 32, wherein each projection of the plurality of projections is spaced from adjacent projections of the plurality of projections to disrupt a flow of combustion gas across the second surface.

37. The Mongolian griddle assembly of claim 32, further comprising a wall disposed on and extending from the second surface to disrupt combustion gas flow across the second surface.

38. The Mongolian griddle assembly of claim 32, further comprising a channel formed in the second surface to promote combustion gas flow across the second surface.

39. The Mongolian griddle assembly of claim 32, wherein with the cylindrical griddle plate disposed on the annular wall, the second surface faces the heat source such that each projection of the plurality of projections extends from the second surface towards the heat source.
